(19) United States
(12) Patent Application Publication
(10) Pub. No.: US 2010/0103383 A1
(43) Pub. Date: Apr. 29, 2010

(54) HEAT-DISSIPATING MEMBER FOR LIGHT SOURCE OF PROJECTOR

(75) Inventors: Jin-Teng Lin, Taichung (TW); Shish-Ming Lee, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/360,127

(22) Filed: Jan. 27, 2009

(30) Foreign Application Priority Data
Oct. 29, 2008 (TW) 97219351

(51) Int. Cl. G03B 21/16

(52) U.S. Cl. 353/61

(57) ABSTRACT

A heat-dissipating member for a light source of a projector includes a heat-dissipating sheet connected to the light source of the projector and a fan installed on one side of the heat-dissipating sheet. The heat-dissipating sheet includes a heat-conducting board connected to the light source, a plurality of wings protruding from the heat-conducting board, and a side board protruding from one end of the heat-conducting board to a direction away from the wings and approaching the fan. A surface of the side board facing the fan is wave-shaped. The heat-dissipating member for a light source of a projector provides less volume and ensures the light source to work within a normal working temperature range.

### CROSS REFERENCE TO RELATED APPLICATIONS

This Application claims priority of Taiwan Patent Application No. 97219351, filed on Oct. 29, 2008, the entirety of which is incorporated by reference herein.

### BACKGROUND OF THE INVENTION

1. Field of the Invention

The present invention relates to a component of a projector, and more particularly to a heat-dissipating member for a light source of a projector.

2. Description of the Related Art

Nowadays, projectors are generally used. Light from a light source is projected on a screen via an optical system. When the light source operates, much heat is generated. To keep the light source of the projector stable and increase the lifespan of the projector, the light source must operate within a normal working temperature. Thus, a heat-dissipating fan is installed near the light source of the projector.

FIG. 1 is a schematic view of an optical system and a heat-dissipating member of a conventional projector. Referring FIG. 1, an LED 1 is used as a light source and is fixed on the optical system 2 via a screw. A heat-dissipating sheet 3 is installed on a back surface of the LED 1. When LED 1 works, the heat generated therefrom is transmitted to the heat-dissipating sheet 3. A fan 4 is installed on one side of the heat-dissipating sheet 3 and is fixed on a shell (not shown). When operating, the fan 4 rotates to dissipate heat with air out of the projector. For the heat-dissipating member, there is a plural amount of heat-dissipating sheets 3, and the heat-dissipating sheets 3 are arranged at intervals. The heat-dissipating sheet 3 is a rectangle sheet, and the length thereof is equal to the diameter of the fan 4. Usually, the volume of the heat-dissipating sheet 3 is relatively great.

The installation of the heat-dissipating member for the light source is related to the size, the position and airflow rate of the fan 4. The working temperature of an LED 1 ranges from 25 to 85 □, and the temperature of an LED 1 with highest radiating color ranges from 25 to 60° C. A lower temperature for the LED 1 is considered better. Meanwhile, the volume of the projector is small and thin, but the volume of the conventional heat-dissipating sheet 3 can not effectively decreased. Thus, a heat-dissipating member with decreased volume providing high heat dissipating performance for a light source to operate at a normal working temperature is desired.

### BRIEF SUMMARY OF THE INVENTION

The invention solves a problem of the conventional heat-dissipating member for a light source of a projector with greater volume. The invention provides a heat-dissipating member for a light source of a projector. The heat-dissipating member has lesser volume than the conventional art and allows a light source to operate under a normal working temperature range.

The invention provides a heat-dissipating member for a light source of a projector which comprises a heat-dissipating sheet connected to the light source of the projector and a fan installed on one side of the heat-dissipating sheet. The heat-dissipating sheet comprises a heat-conducting board connected to the light source, a plurality of wings protruding from the heat-conducting board, and a side board protruding from one end of the heat-conducting board to a direction away from the wings and approaching the fan. A surface of the side board facing the fan is wave-shaped.

Note that the sum of the length of the side board and the length of the wing is equal to the diameter of the fan.

Note that the diameter of the fan is equal to the height of the light source.

Note that the thickness of the side board near the wings is less than the thickness of the side board away from the wings.

Note that the fan comprises an inlet, and an end of the heat-dissipating member opposite to the fan is an outlet.

Note that the heat-conducting board comprises a heat-conducting film.

Note that the heat-dissipating sheet is made of metal with high conductivity.

The heat-dissipating member for a light source of the invention decreases the volume of the heat-dissipating sheet to decrease volume of the heat-dissipating member and ensures that the light source works under normal working temperature ranges.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of an optical system and a heat-dissipating member of a conventional projector;

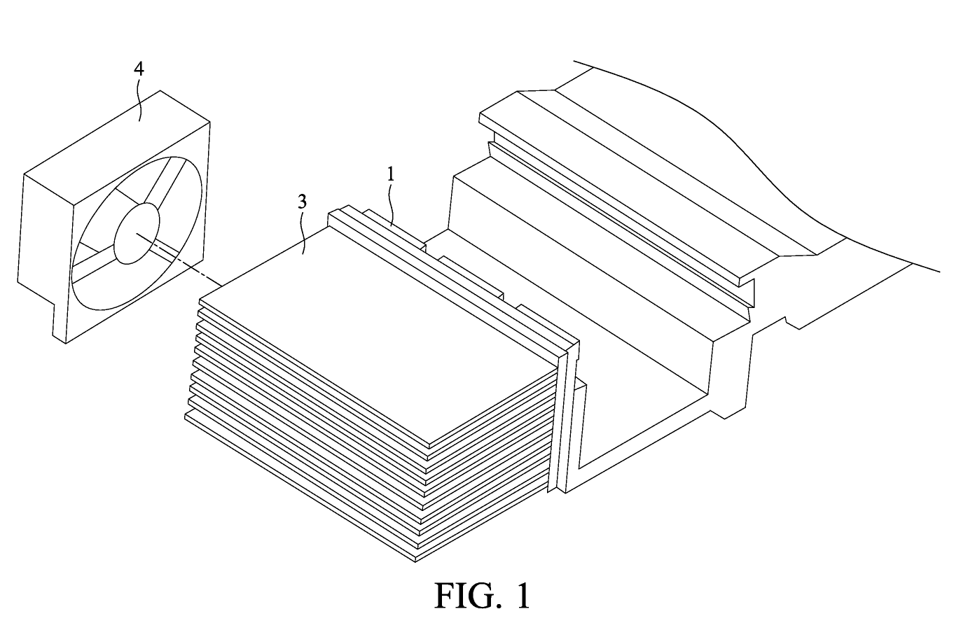

FIG. 2 is an exploded view of an optical system and a heat-dissipating member of a projector of the invention;

FIG. 3 is a schematic view a heat-dissipating sheet of a heat-dissipating member of a projector of the invention;

FIG. 4 is a chart of the thermal analysis of a heat-dissipating member of the invention; and

FIG. 5 is a chart of the thermal analysis of a heat-dissipating member of another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

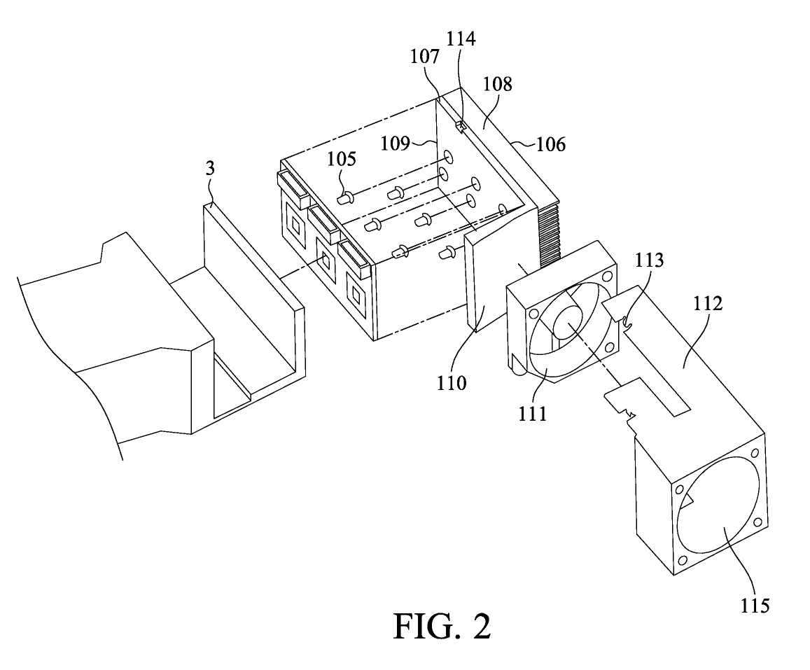

Referring to FIG. 2, a projector of the invention comprises an optical system 101, a light source 102 fixed on the optical system 101, and a heat-dissipating member 103 for the light source 102. The light source 102 comprises a metal substrate, a chip on the metal substrate to connect to a ceramic material and a semiconductor (not shown). The light source 102, for example an LED, radiates a light to pass through the optical system 101 and be projected onto a screen from a lens.

The light source 102 is fixed on the optical system 101 via a screw. A heat-dissipating sheet 106 is installed and is tightly fixed onto the back of the light source 102. The heat-dissipating sheet 106 is made of metal with high conductivity, for example copper or aluminum. The heat-dissipating sheet 106 comprises a heat-conducting board 107 and a plurality of wings 108 protruding from the heat-conducting board 107. The heat-conducting board 107 is connected to the back of the light source 102, and the length of the heat-conducting board 107 is equal to the length of the light source 102. To conduct heat efficiently, the heat-conducting board 107 comprises a heat-conducting film 109, and the heat-conducting film 109 is adhesive.

The heat-dissipating sheet 106 further comprises a side board 1 10. The side board 110 protrudes from one end of the heat-conducting board 107 to a direction away from the wings 108 to arrive at the side of the optical system 101, and the side board 110 is perpendicular to the heat-conducting board 107. A shell 112 is installed on the outer side of the heat-dissipating member 103. A protrusion 113 is installed on the shell 112. An engaging groove 114 is installed on the heat-conducting board 107. The protrusion 113 enters the engaging groove 114 to fix the shell 112 onto the outer side of the heat-conducting board 107. A hole 115 is installed on the side of the shell 112. The fan 111 is fixed on the hole 115 near the side board 110 of the heat-dissipating sheet 106. After assembly is completed, the shell 112 covers the heat-dissipating sheet 106 and the fan 111. The fan 111 is used as an inlet, and an end of the heat-dissipating member 103 opposite to the fan 111 is an outlet. Or, the fan 111 is used as an outlet, and an end of the heat-dissipating member 103 opposite to the fan 111 is an inlet for dissipating heat from the heat-dissipating sheet 106.

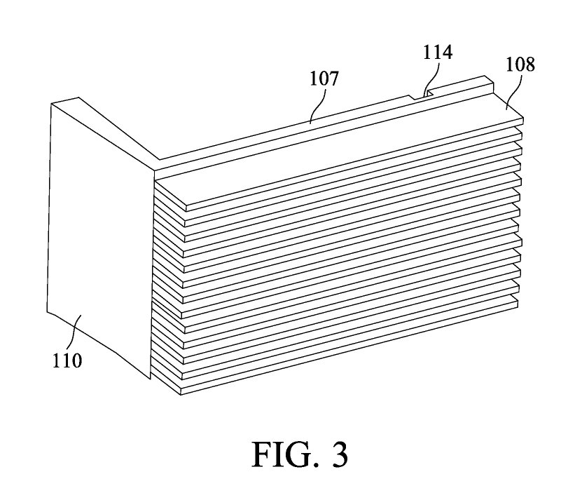

Referring to FIGS. 2 and 3, the heat-conducting board 107, the wings 108, and side board 110 of the heat-dissipating sheet 106 form an L shaped structure. The sum of the length of the side board 110 and the length of the wing 108 is equal to the diameter of the fan 111. The diameter of the fan 111 is equal to the height of the light source 102. Compared with conventional art, the invention decreases the length of the wings 108. To easily dissipate heat, noise generated by airflow flowing to the fan 111 is controlled within an allowable range, to allow the airflow to smoothly and stably flow. A surface of the side board 110 toward the fan 111 is wave-shaped. The thickness of the side board 110 near the wings 108 is less than the thickness of the side board 110 away from the wings 108 so that the airflow smoothly flows from the wings 108 to the fan 111.

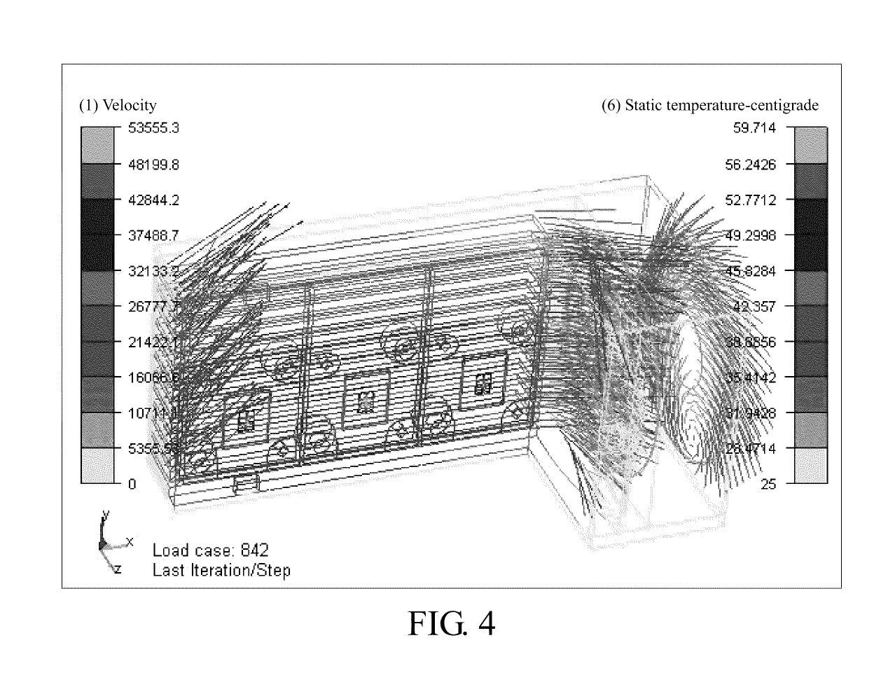

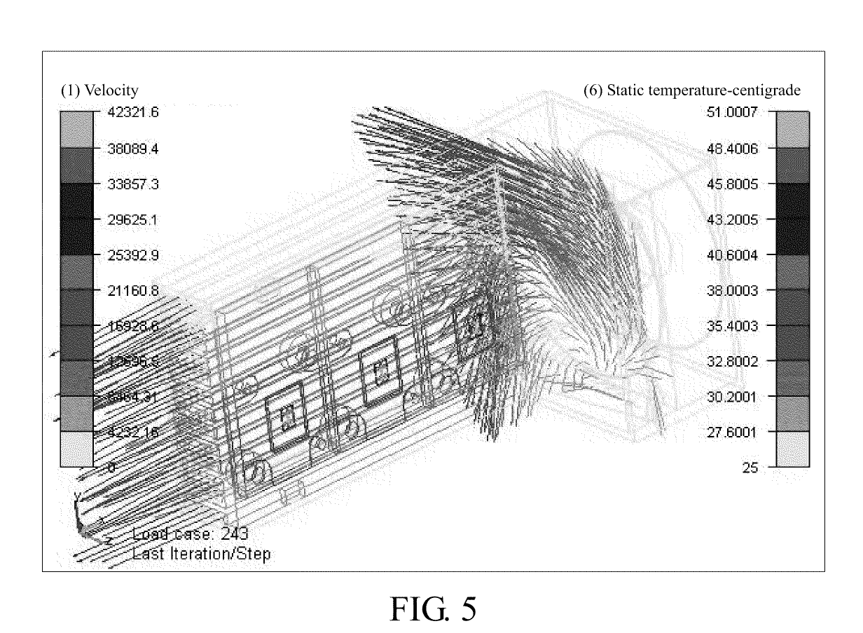

FIGS. 4 and 5 are charts of the thermal analysis of a heat-dissipating member of the invention. The heat-dissipating member is analyzed via thermal analysis software. FIG. 4 is a chart of the thermal analysis, wherein the fan 111 is used as an outlet, and an end of the heat-dissipating member 103 opposite to the fan 111 is an inlet. The average wind velocity at the inlet is 20.X m/s, and the average wind velocity at the outlet is 10.X m/s. The highest temperature at the center of the chip of the light source 102 is about 59.71° C. The temperature of the light source 102 is about 47° C. The above temperatures are within the range of the normal working temperature, 25-85° C. and within the range of the best radiating color temperature, 25-60° C. The computer confirms that the coefficient is balanced.

FIG. 5 is a chart of the thermal analysis, wherein the fan 111 is used as an inlet, and an end of the heat-dissipating member 103 opposite to the fan 111 is an outlet. The average wind velocity at the inlet is 10.X m/s, and the average wind velocity at the outlet is 16.X m/s. The highest temperature at the center of the chip of the light source 102 is about 51° C. The temperature of the light source 102 is about 40° C. The above temperatures are within the range of the normal working temperature, 25-85° C. and within the range of the best radiating color temperature, 25-60° C. The computer confirms that the coefficient is balanced. Noise from the invention is less than that of those from conventional art.

For practical designs, the thermal analysis software can calculates the greatest wind velocity for fans 111 with same sizes to help design the shape of the heat-dissipating sheet 106.

Compared with conventional art, the volume of the heat-dissipating member 103 of the invention is decreased, and the light source 102 can work within a normal working temperature range.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A heat-dissipating member for a light source of a projector, comprising:
a heat-dissipating sheet, connected to the light source of the projector; and
a fan, installed on one side of the heat-dissipating sheet, wherein the heat-dissipating sheet comprises:
a heat-conducting board, connected to the light source;
a plurality of wings, protruding from the heat-conducting board; and
a side board, protruding from one end of the heat-conducting board to a direction away from the wings and approaching the fan, wherein a surface of the side board facing the fan is wave-shaped.

2. The heat-dissipating member as claimed in claim 1, wherein the sum of the length of the side board and the length of the wing is equal to the diameter of the fan.

3. The heat-dissipating member as claimed in claim 1, wherein the diameter of the fan is equal to the height of the light source.

4. The heat-dissipating member as claimed in claim 1, wherein the thickness of the side board near the wings is less than the thickness of the side board away from the wings.

5. The heat-dissipating member as claimed in claim 1, wherein the fan comprises an inlet, and an end of the heat-dissipating member opposite to the fan is an outlet.

6. The heat-dissipating member as claimed in claim 1, wherein the heat-conducting board comprises a heat-conducting film.

7. The heat-dissipating member as claimed in claim 1, wherein the heat-dissipating sheet is made of metal with high conductivity.
